(19) United States
(12) Patent Application Publication
(10) Pub. No.: US 2005/0095558 A1
(43) Pub. Date: May 5, 2005

(54) Interproximal composite carver

(76) Inventor: Michael L. Jones, Avondale, AZ (US)

Correspondence Address: Richard C. Litman;LITMAN LAW OFFICES, LTD., P.O. Box 15035, Arlington, VA, 22215, US

(21) Appl. No.: 10/979,143

(22) Filed: Nov. 3, 2004

Related U.S. Application Data
(60) Provisional application No. 60/516,729, filed on Nov. 4, 2003.

(51) Int. Cl. A61C 3/02

(52) U.S. Cl. 433/144

(57) ABSTRACT

The interproximal composite carver is a dental instrument configured to carve composite material used in dental fillings from the interproximal surfaces of a tooth. The instrument has an elongated handle with a curved blade attached to each of its two ends. The cutting edge of one of the blades is oriented to carve along the left side of a tooth when the blade is inserted into a patient's mouth, and the cutting edge of the other blade is oriented to carve along the right side a tooth when inserted into a patient's mouth. With the cutting edges oriented in opposite directions, the instrument can be used in an ergonomic manner on either side of a given tooth by simply changing which end of the instrument is inserted into the patient's mouth.

### CROSS-REFERENCE TO RELATED APPLICATION

This application claims the benefit of U.S. Provisional Patent Application Ser. No. 60/516,729, filed Nov. 4, 2003.

### BACKGROUND OF THE INVENTION

1. Field of the Invention

The present invention relates to dental tools, and more particularly to an interproximal composite carver used to remove excess composite or resin cement from the interproximal surfaces of a tooth.

2. Description of the Related Art

A white dental filling is formed in the cavity of a tooth by applying a composite material to the cavity in a three-step process. First, the cavity is filled with the composite material. Then, the composite is cured, or hardened, by subjecting it to ultraviolet light. Finally, the excess composite is removed by scraping, or carving, it away from the tooth.

When removing excess composite, it is important to carefully remove all of the excess, particularly along the gum line and between the teeth. Any excess composite remaining on a tooth after a filling is formed can trap food particles or cause discomfort to the patient. However, removing excess composite is difficult due to its hardness and due to the lack of dental instruments designed specifically for this task.

Currently, excess composite is typically removed from a tooth with the aid an instrument designed for another purpose, such as an instrument for removing plaque having a cylindrical handle with a pick at one end or an instrument for handling silver filling material having a single blade extending from a cylindrical handle. But neither of these types of instruments is well suited for use in removing excess composite from interproximal surfaces of a tooth. Specifically, neither incorporates a blade that is contoured for use on the curved interproximal surfaces of a tooth nor does either incorporate a carving edge disposed at an ergonomic angle with respect to the instrument handle. Further, neither type of instrument includes two blades disposed on opposite ends of the handle so that one blade is configured and angled for ergonomic use on one side of a tooth and the other blade is configured and angled for ergonomic use on the other side of the same tooth. A discussion of dental tools to remove excess composite or resin cement from the interproximal surfaces of a tooth follows.

U.S. Des. Pat. No. 435,293 issued Dec. 19, 2000 to B. Tang (dental tool); U.S. Pat. No. 1,369,582 issued Feb. 22, 1921 to L. P. Wagner (dental tool); U.S. Pat. No. 5,816,806 issued Oct. 6, 1998 to W. B. Herbst et al. (dental instrument with large molded handles); U.S. Pat. No. 5,913,682 issued Jun. 22, 1999 to K. S. Strate (plaque removing tool); and U.S. Pat. No. 6,247,477 issued Jun. 19, 2001 to E. C. Wagner (Multifunction dental appliance) all teach devices having a cylindrical handle with a curved pick extending from one end. However, while the curved picks taught by these patents may be useful for removing plaque, they are not well suited for carving excess composite from a layer of composite or from the surface of a tooth. Further, each of the aforementioned patents teaches a curved pick that is entirely disposed within the plane of the axis of the handle. Thus, none of these devices is designed for use at an angle that minimizes discomfort to the patient.

U.S. Des. Pat. No. 199,832 issued Dec. 15, 1964 to W. Edelman et al. (toothpick); U.S. Pat. No. 3,101,727 issued Aug. 27, 1963 A. D. Wiseman (tooth cleaning device); and U.S. Pat. No. 6;526,993 issued Mar. 4, 2003 to E. C. Wagner (dental implement with comfit grip) teach devices having an edged planar surface extending from a handle or grip. While each device is intended for use in cleaning teeth or dispensing a liquid agent on teeth, none incorporates a curved edge suitable for carving composite on interproximal surfaces of a tooth.

U.S. Pat. No. 4,060,897 issued Dec. 6, 1977 to J. Greenstein teaches a device for cutting and lifting dental restoration material and U.S. Pat. Nos. 5,127,833 and 5,169,313 issued, respectively, Jul. 7, 1992 and Dec. 8, 1992 to J. M. Kline teach a device for scaling teeth that incorporates an arcuately formed shaft to help prevent contact between the sharp edge of the device and the patient's cheek or tongue. Neither of these devices, however, incorporates a blade contoured to carve composite from the interproximal surfaces of a tooth. Nor do either of the devices incorporate two mirror-imaged blades extending from opposite ends of a cylindrical handle so that each blade is in a plane at an angle with the axis of the handle.

Consequently, none of the above inventions and patents, taken either singly or in combination, is seen to describe the instant invention as claimed. Thus, a dental tool solving the aforementioned problems is desired.

### SUMMARY OF THE INVENTION

The interproximal composite carver is a dental instrument configured to carve composite material used in dental fillings from the interproximal surfaces of a tooth. The instrument has an elongated handle with a curved blade attached to each of its two ends. Each blade is oriented at an angle relative to the handle so that each blade may be easily manipulated in the mouth of a dental patient with minimal discomfort to the patient. The cutting edge of one of the blades is oriented to carve along the left side of a tooth when the blade is inserted into a patient's mouth, and the cutting edge of the other blade is oriented to carve along the right side a tooth when inserted into a patient's mouth. With the cutting edges oriented in opposite directions, the instrument can be used in an ergonomic manner on either side of a given tooth by simply changing which end of the instrument is inserted into the patient's mouth.

Accordingly, it is a principal object of the invention to provide a dental instrument for carving composite material used in dental fillings from the interproximal surfaces of a tooth.

It is another object of the invention to provide a dental instrument that has an elongated handle with a blade attached to each of the two ends of the handle.

It is a further object of the invention to provide a dental instrument with blades attached to the handle at angles relative to the handle so that each blade can be inserted into the mouth of a patient without requiring excessive stretching of the patient's lips and cheeks.

Still another object of the invention is to provide a dental instrument with a first blade that is configured to carve along the left side of a tooth and a second blade configured to carve along the right side of a tooth so that the instrument can be used on either side of a given tooth by simply changing which end of the instrument is inserted into the patient's mouth.

Further, it is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of an interproximal composite carver according to the present invention.

FIG. 2 is an elevational side view of an interproximal composite carver according to the present invention.

FIG. 3 is a fragmented top view of an interproximal composite carver according to the present invention depicting one end of the invention.

FIG. 4 is a fragmented side view of an interproximal composite carver according to the present invention depicting one end of the invention.

FIG. 5 is a fragmented perspective view of an interproximal composite carver according to the present invention depicting one end of the invention.

Similar reference characters denote corresponding features consistently throughout the attached drawings.

### DETAILED DESCRIPTION OF THE PREFERRED EMBODIMENT

The present invention is an interproximal composite carver, designated generally as 10 in the drawings. The carver 10 is a dental instrument configured to carve composite material used in dental fillings from the interproximal surfaces of a tooth.

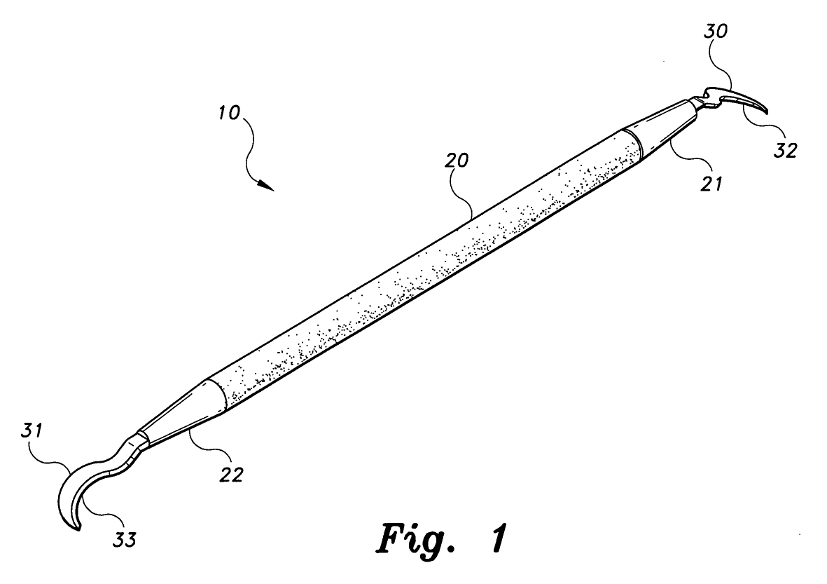

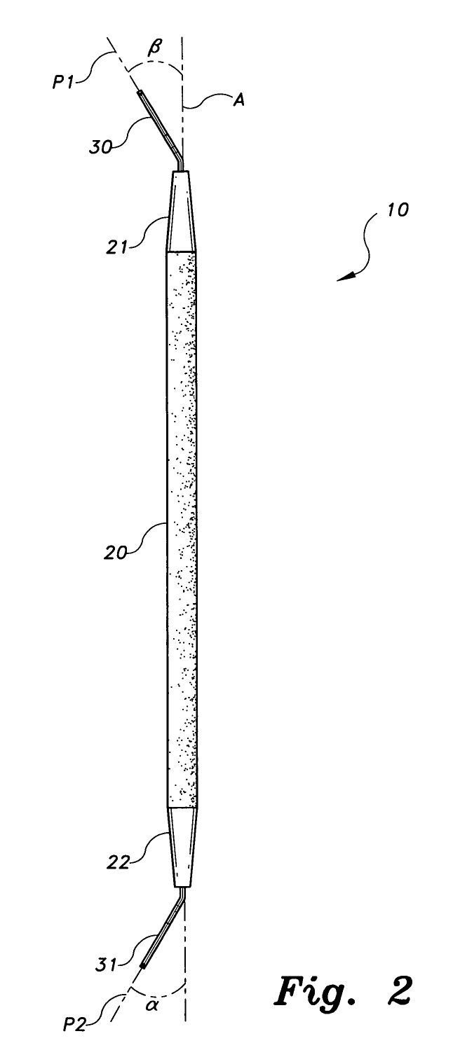

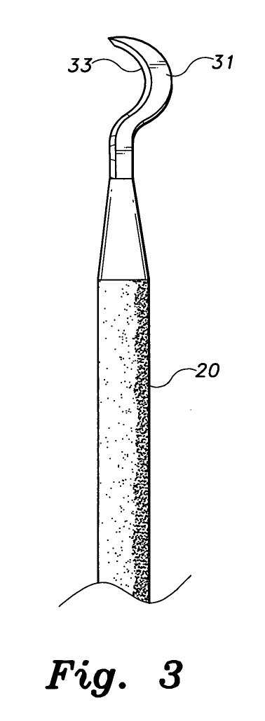

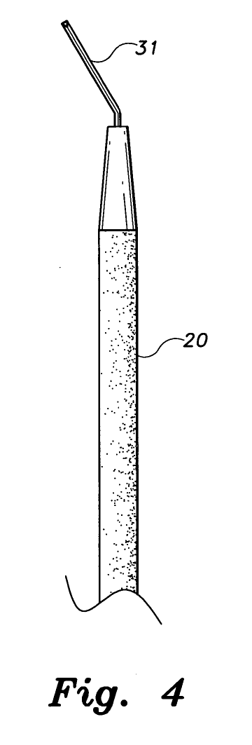

As shown in FIGS. 1-5, the instrument has an elongated handle 20 with a curved blade 30 and 31 attached to each of its two ends 21 and 22. Each blade 30 and 31, as shown in FIG. 2, is in a plane P1 and P2 that is oriented at an angle or to the central axis A of the handle 20. With the blades 30 and 31 angled relative to the handle 20, each blade 30 and 31 can be positioned against a tooth without requiring excessive stretching of the patient's lips and cheeks by the instrument handle 20. Thus, the angled blades 30 and 31 allow a dentist to hold the instrument 10 in a comfortable position and to easily manipulate the blades 30 and 31 in the mouth of a patient with minimal discomfort to the patient.

The carver 10 is designed for use in one of two primary positions. In the upright position, the blades 30 and 31 are slanted downward from the handle 20 (as shown in FIG. 1) and the carver 10 is better suited for use on a patient's upper teeth. In the inverted position, the blades 30 and 31 are slanted upward from the handle 20 and the carver 10 is better suited for use on a patient's lower teeth.

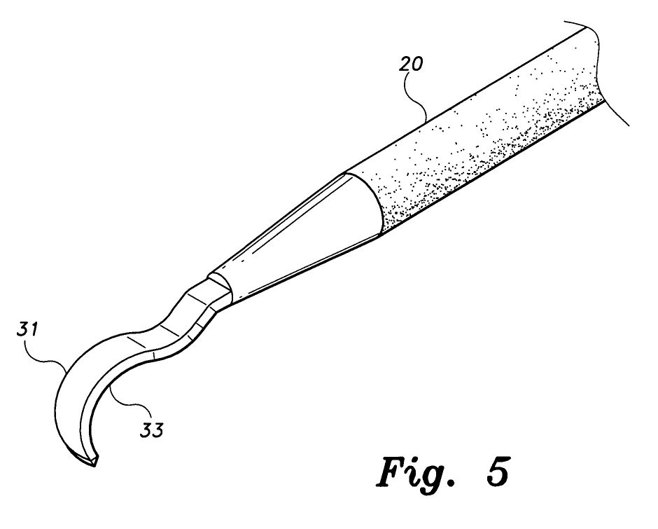

When the instrument 10 is in upright position (FIGS. 1 and 5), one 31 of its blades 30 and 31 curves towards the left and has an arcuate cutting edge 0.33 contoured to carve along the right side of an upper tooth. However, when the carver 10 is in the inverted position, the same blade 31 curves toward the right and has an arcuate cutting edge 33 contoured to carve along the left side of a lower tooth. Conversely, the opposite blade 30 curves toward the right when the instrument 10 is in the upright position and therefore has an arcuate cutting edge 32 contoured to carve along the left side of an upper tooth, but curves toward the left when the instrument 10 is in the inverted position and therefore has an arcuate cutting edge 32 contoured to carve along the right side of a lower tooth.

Hence, with the cutting edges 32 and 33 oriented in opposite directions, the instrument 0.10 can be used in an ergonomic manner on either side of a given tooth by simply changing which end 21 and 22 of the instrument 10 is inserted into the patient's mouth.

In addition to carving excess composite, the interproximal composite carver 10 can be used to carve excess resin cement when used to secure a crown to a tooth abutment.

The carver 10 is constructed of metal and has a cylindrical handle 20 that tapers at each end 21 and 22. The tapered and cylindrical portions of the handle 20 may be knurled.

It is to be understood that the present invention is not limited to the embodiment described above, but encompasses any and all embodiments within the scope of the following claims.

1. An interproximal composite carver, comprising:
an elongated handle having a first end and a second end, the handle defining a central axis extending through the first and second ends;
a first curved blade extending from the first end of the handle, the first blade having an arcuate cutting edge and being disposed in a first plane; and
a second curved blade extending from the second end of the handle, the second blade having an arcuate cutting edge, the first and second blades being disposed in planes forming at least one angle relative to the central axis of the handle.

2. The interproximal composite carver according to claim 1, wherein when said handle is disposed horizontally with said first and second curved blades angled downward, the arcuate cutting edge of said first curved blade curves toward the left and the arcuate cutting edge of said second curved blade curves toward the right.

3. The interproximal composite carver according to claim 1, wherein said handle is cylindrical.

4. The interproximal composite carver according to claim 1, wherein the first and the second ends of said handle are tapered.

5. The interproximal composite carver according to claim 1, wherein said handle is knurled.

6. The interproximal composite carver according to claim 1, wherein the handle and the blades are constructed of metal.

7. A method of using the interproximal composite carver according to claim 1 for the removal of excess composite cement from the interproximal surfaces of a tooth, comprising the steps of:
selecting a tooth to work on from the group consisting of right side of upper tooth, left side of upper tooth, right side of lower tooth, and left side of lower tooth;
positioning one of the curved blades over the composite cement on one side of the selected tooth;
removing the composite cement;
inverting the handle;
positioning the opposite curved blade on the opposite side of the selected tooth; and
completing the removal of the composite cement.
